(19) United States
(12) Patent Application Publication
(10) Pub. No.: US 2008/0040436 A1
(43) Pub. Date: Feb. 14, 2008

(54) Instant messaging integrated in a browser

(75) Inventors: Bharani Vasudev Setlur, Mumbai (IN); Kiran Kulkarni, Mumbai (IN); Vinay Vishwanathan, Mumbai (IN)

Correspondence Address: Ashok Tankha,;Lipton, Weinberger & Husick, 36 Greenleigh Drive, Sewell, NJ, 08080, US

(73) Assignee: Geodesic Information Systems Ltd, Mumbai (IN)

(21) Appl. No.: 11/801,286

(22) Filed: May 9, 2007

(30) Foreign Application Priority Data
Aug. 11, 2006 (IN) 2062/CHE/2006

(51) Int. Cl. G06F 15/16

(52) U.S. Cl. 709/206

(57) ABSTRACT

Disclosed herein is a method and system of providing an instant messenger on a toolbar over an internet web browser. The system allows the user to access a list of instant messenger contacts in a buddy list bar upon successful authentication. The system displays multiple instant messenger accounts of a plurality of instant messenger vendors. The system provides a facility within the user interface to choose a contact, and initiate instant messaging by inputting text messages in a text box provided within the browser toolbar itself, thereby eliminating the need for a user to shift through applications, or tabs, or windows. The system also allows for the viewing the conversation between selected contacts using a conversation box integrated within the toolbar.

### BACKGROUND OF THE INVENTION

This invention in general relates to instant messaging and in particular relates to a system of integrating an instant messaging application into an internet browser toolbar.

Instant messaging allows real time exchange of dynamic dialogs between two or more users. Over the last few years, instant messaging has gone from an occasionally used application to the central point of a computing experience. Due to the growing consumer use and demand, it has become an element of the computing experience that constantly needs to be improvised upon.

To initiate instant messaging, the user needs to download and install new software on his computer, i.e., install an instant messaging application available with any of the existing plurality of instant messenger vendors. Commuting users or users who use, or who do not use the same system at all times find it difficult to download and install the software on each of the system they use to access instant messaging. There is a need to eliminate the process of downloading and installing an instant messaging application prior to the initialization of instant messaging.

The present applications used for instant messaging occupy a large part of the screen. There exists a need for instant messaging applications that saves real estate on a user's computer screen.

While using an instant messenger, the user needs to shift through applications or tabs or windows. There is a market need for an instant messaging service that can be used without having to shift through applications or tabs or windows, making the instant messaging service easier to use.

Another important shift in the usage of computers and the internet over the past few years is the increasing centrality of the web browser. Users have come to spend a majority of their time online on the browser. Increasingly, the users expectation is that all activities on the computer and the internet should be available through the browser.

Thus there is a large market trend and an unmet need for making the instant messaging facility available as a seamless part of a web browser. Further, other services like access to news, weather, stock information etc., and applications like calls using Voice over IP (VoIP) need also be integrated along with the access to interoperable IM inside the browser environment.

### SUMMARY OF THE INVENTION

Disclosed herein is a method and system of providing an instant messenger on a toolbar over an internet web browser. The system allows the user to access a list of instant messenger contacts in a buddy list bar upon successful authentication. The system displays multiple instant messenger accounts of a plurality of instant messenger vendors. The system provides a facility within the user interface to choose a contact, and initiate instant messaging by inputting text messages in a text box provided within the browser toolbar itself, thereby eliminating the need for a user to shift through applications or tabs or windows. The system also allows for viewing the conversation between selected contacts using a conversation box integrated within the toolbar.

Disclosed herein is a method to eliminate the need to shift through applications or tabs or windows for access and use of an instant messenger.

Also disclosed herein is a method to allow for the instant messaging application to save a large amount of real-estate on a computer screen by integrating the instant messaging service within the browser toolbar.

Also disclosed herein is a method is to facilitate access to multiple important applications such as co browsing, VoIP, and quick information such as news, stock-market, weather etc can be viewed through really simple syndication (RSS) feeds by integrating these additional applications along with the instant messaging service within the browser toolbar.

Also disclosed herein is a method to enable compatibility with the existing plurality of internet browsers, including but not restricted to Microsoft internet explorer, Mozilla internet explorer and Netscape internet explorer. The present method of invention needs no modification while being implemented in conjunction with the existing internet browsers.

Also disclosed herein is a method to enable compatibility with the existing instant messenger applications including, but not restricted to yahoo, MSN, AIM and G talk.

### BRIEF DESCRIPTION OF THE DRAWINGS

The foregoing summary, as well as the following detailed description of the embodiments, is better understood when read in conjunction with the appended drawings. For the purpose of illustrating the invention, there is shown in the drawings exemplary constructions of the invention; however, the invention is not limited to the specific methods and instrumentalities disclosed.

FIG. 1 illustrates a method of integrating the instant messaging application into an internet browser toolbar.

FIG. 2A illustrates the different tabs located on the toolbar.

FIG. 2B exemplarily illustrates a screen shot for a method of user login.

FIG. 2C exemplarily illustrates a screen shot for a method of user authentication.

FIG. 2D exemplarily illustrates a screen shot that displays the user's instant messenger contacts.

FIG. 2E exemplarily illustrates a screen shot that displays the input of a text message.

FIG. 2F exemplarily illustrates a screen shot that displays conversation history in the instant messaging system.

FIG. 3 exemplarily illustrates a screen shot that displays multiple functionalities integrated in the browser toolbar.

### DETAILED DESCRIPTION OF THE INVENTION

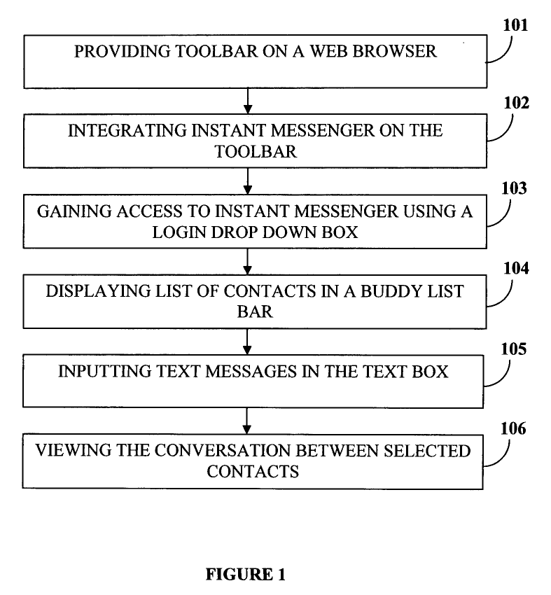

FIG. 1 illustrates a method of communication on the toolbar of a web browser 101 via the web by integrating an instant messaging application into an internet browser toolbar 102. The method incorporates drop down boxes and text boxes within the toolbar. The user can login as well as type in and send the message from the tabs provided within the toolbar, without having to shift to a different application or window. A login drop down box is used for gaining access to the instant messenger 103. After a user registers with the instant messenger and is authenticated, a list of contacts is displayed on the buddy list bar 104. A user selects a contact from the buddy list and inputs a text message that he or she wants to send to the selected contact 105. All the messages exchanged between the selected contact and the user is provided in a drop down conversation box 106. The words “contacts” and “buddies” are herein used interchangeably.

The following process exemplifies the method for achieving instant messaging using the toolbar alone, eliminating the need of any supplementary component. The user clicks on the login link that displays a list of instant messenger vendors such as Yahoo, MSN, AIM and G talk. Upon the selection of any one of the instant messenger vendors from the list, for example, Yahoo messenger, the IM application would need to authenticate the user to the IM network. The user provides the Yahoo messenger login identity and password. After authentication, the user accesses his or her list of instant messenger contacts present in the buddy list. To initiate a chat with a selected contact, the user enters the conversation interface, while the name of the selected contact continues to be displayed in the contact list drop down box. The user inputs the text message in the text box and clicks on the send icon. If the selected contact is online, a conversation is initiated. The messages sent and replies received are displayed in a drop down text box. The messages may be saved and made available for review at any future point in time.

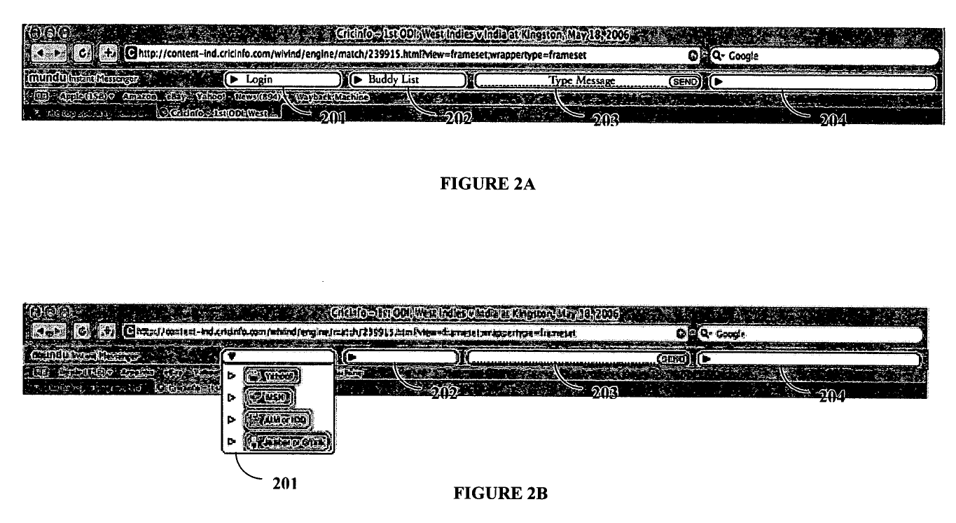

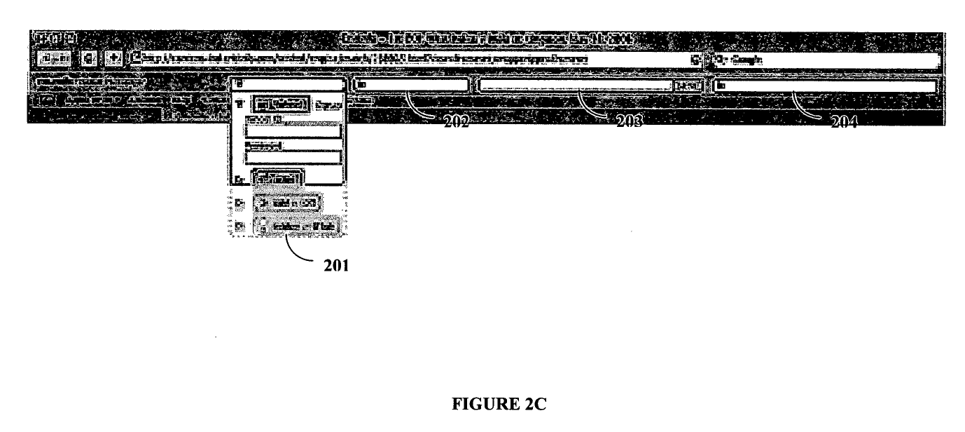

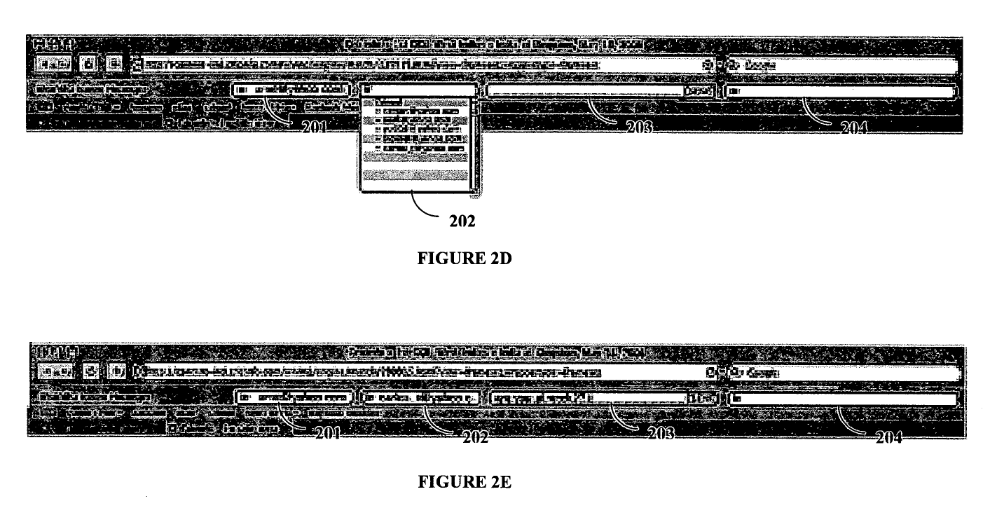

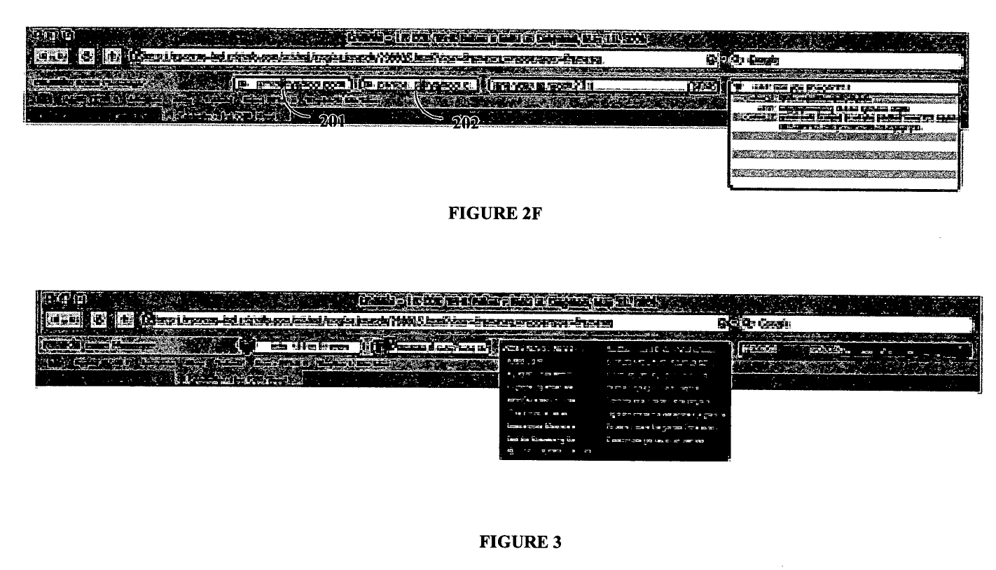

FIG. 2A illustrates the different tabs present on the toolbar. The toolbar provides an interoperable login dropdown box 201 for user login. A drop down box 202, for displaying the list of contacts is located adjacent to the login dropdown box. The toolbar includes a user interface text bar, i.e., a text bar 203 that provides space for the user to type in and send the message. Another dropdown box 204 is provided for displaying the complete conversation with the buddy whose name the user has selected from his contact list.

The tabs are placed adjacent to each other, in the same order as mentioned in the foregoing description of the figures.

FIG. 2B illustrates the method of user login. The login dropdown box 201 allows for the user to choose from a list of existing service providers, for example, Yahoo!, MSN, AIM, etc. The method of the present invention is compatible with the existing plurality of instant messenger applications and allows the user to access multiple instant messenger accounts of a plurality of instant messenger vendors without having to open different windows for each of the instant messenger applications.

FIG. 2C illustrates a method of user authentication. The user inputs a login identity and password for authentication. The user may select one or more instant messaging service providers and login using a valid user name and password for the each of the instant messenger accounts.

FIG. 2D illustrates a method for displaying contacts. After successful authentication of a user, a drop down box displays a list of names in the user's contact list. The user selects one contact at a time from the buddy list in order to initiate instant messaging or a chat between the two. The name of the person whom the user selects from his buddy list is displayed in the tool bar. This acts as a clear indicator of the name of the person with whom the user is currently in conversation with. An icon appears at the end of the name to indicate the arrival of a message or a buzz from another buddy, in which case the user would tap on the frame to check and reply the received message.

FIG. 2E illustrates a method for inputting the text message. The toolbar contains a wide blank space for the user message, followed by a send icon. After the user finishes typing the message, he or she taps on the send icon to allow the transmission of the message via the network.

FIG. 2F illustrates a method for displaying conversation history. The messages exchanged between the user and his selected contact(s), along with the sender's name appear in the bar. This enables the user to review the current conversation between the user and the buddy.

FIG. 3 illustrates a method of introducing multiple functionalities in the browser toolbar. In the present invention the toolbar has been used primarily as a subset of the main browser window. With the instant messenger in the toolbar the user can move into a distinct user space that can be toggled to access multiple important applications from within the space of the browser.

The method of present invention combines multiple functionalities in the form of embedded applications, along with the integration of the instant messaging service within the browser toolbar. Examples of the multiple functionality within the toolbar comprise obtaining quick information such as news, stock-market, weather, etc. to be viewed through really simple syndication (RSS) feeds.

In one embodiment of the invention, mail alerts may be obtained. A user is alerted by a flash on an icon on the toolbar on the arrival of a new message. In another embodiment of the invention, the user may be alerted on arrival of a new message even when he or she is off-line. Such an alert message is sent on the mobile phone of the user.

In another embodiment of the invention the online status of a person in the contact list may be checked. When the user logs in successfully and views a display of contact on his buddy list the user is informed of all the contacts which are currently online. The names of the buddies who are online and those who are off-line appear in different colors so as to enable the user to determine the presence status of the buddy. There is a notification of active buddies and frequent buddies. An active buddy is a buddy with whom a user is having a conversation. Frequent buddy is the buddy with who user converses frequently.

In another embodiment of the method and system of the present invention interactive co-browsing is facilitated. A user can co-browse websites with one or more friends. The co-browsing session is made interactive by employing the method and system of the current invention. It provides a method and system for sharing website information, where readers of a plurality of multiple instant messenger accounts can collaboratively discuss the subject of interest on a website, and where all instant messenger accounts need not necessarily be installed on the reader's computer, and the host website ensures that while the instant messenger discussions take place, the reader and their contact friends continue to be within the environment of the host website

Additional multi-functionality features include referring a page, i.e., adding the IM referral functionality to the toolbar. A user can refer any page that is displayed in the browser window to a friend in his buddy-list and proceed to have a conversation or even co-browse the site. In another embodiment of the invention, the user is provided with a facility to share the experience of surfing, or the ability to do a variety of tasks with one or more people simultaneously, for e.g., playing a game with another user.

The method and system for sharing website information, called referral instant messenger (RIM) is further elaborated in the patent application titled Rereferral Instant Messenger by the same authors of this invention. Referral instant messenger (RIM) enables the transmission of a universal resource locator address of a web page of a host website from one reader to one or more contacts of the reader. In this embodiment of the invention, a RIM link is provided on the browser toolbar. The reader requests for authentication by clicking the link and providing username(s) and password(s) of the instant messenger (IM) accounts. The access to a list of instant messenger contacts of the reader is provided upon successful authentication. The list of contacts and their status is displayed in a user interface. The reader can choose one or more contacts and send the universal resource locator (URL) address of the web page that is currently viewed. This process eliminates the need of the reader leaving the host website in order to pursue instant messaging to send the link to his contacts. In order to access the referral instant messenger (RIM), the web page reader does not have to download and install any new software on his or her computer. The method and system of this invention is independent of the operating system and browser platforms of the reader's computer. A conversation interface is provided within the user interface for the purpose of exchanging messages between the reader and one or more selected contacts. The method and system of referral instant messenger disclosed herein enables readers of a plurality of multiple instant messenger (IM) accounts to collaboratively discuss the subject of interest on a website, without the necessity for instant messenger to be installed on the readers computer, and allows the host website to introduce advertisements in the instant messenger window and while the instant messenger discussions take place, the reader and their contact friends continue to view the host website, whereby the host website ensures that the reader and their contacts spend more time at their website. This results in an improved reading experience, generates more website traffic, increases site registrations and provides a new channel of advertising for the host website.

Yet another example of the enhanced multi-functionality of the present invention is collaborative composing. Collaborative composing allows users to use the toolbar as a high effective means for collaborative composing of documents, text or visuals, etc. Collaborative composing enables a user to incorporate the inputs provided by a number of co-composers in his composed text or video and also allows the composer to edit the inputs provided.

Another embodiment of the multifunctional toolbar allows VoIP calls to be made through an application integrated within the toolbar without having to open a new application or a new window.

An additional feature of the present invention is a memory buffer which enables to create different files to preserve the dialogue list containing the messages from the user and his contact. The offline messages get automatically stored in the respective folders, provided the user has created a folder for that particular contact present in his buddy list.

An additional feature is that the user can selectively display his presence status as online or busy to any contact in the buddy list with merely a click on a button present within the toolbar itself. The user is also allowed to customize and arrange the icons on the toolbar according to his or her preference.

In another embodiment of the invention a buddy, if allowed by the user, may be enabled to view the conversation history of the user. On being granted permission by the user, the buddy can access the folders in which the user's conversations with other contacts have been stored.

In another embodiment of the invention a user may be alerted via the instant messenger on the toolbar, about the arrival of a new message on his or her cell phone. The invention may also enable the user to view and reply the message using their mobile device.

The instant messenger (IM) toolbar makes use of existing IM infrastructure. The IM server acts as a gateway between the toolbar and various messaging services like Yahoo!, MSN, AIM, Jabber, etc. The IM server provides Application Programming Interface (API) for the clients. These APIs are written in JavaScript. After the installation process, the IM toolbar appears as a part of web browser as one of the toolbars. The IM toolbar uses APIs to communicate with IM server and thus gets the functionalities of logging into IM services such as Yahoo!, AIM, MSN, Jabber, etc. Logging in to the IM services provides access to send and receive messages to buddies. The login drop down box takes the login information and service type. The login information is sent to IM server using APIs. The IM server keeps sending login progress. After successful login a buddy list is received. The buddy list is shown in another list box. Buddies are sorted according to group. All off-line buddies are shown in the bottom of the list box. There is a notification of active buddies and frequent buddies. An active buddy is a buddy with whom the user is having a conversation. A frequent buddy is the buddy with who user converses frequently. The user has to first select a buddy from this list box to initiate a conversation. A text box is provided on the toolbar to input text message for the buddy. This message is sent to the current active buddy, using the APIs. The latest message of the conversation is shown on a conversation button. The complete conversation can be viewed on a popup which toggles open and hide state on click of the conversation button.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A method of communication, comprising the steps of:
providing a web browser with a toolbar;
integrating an instant messenger on said tool bar over said web browser;
gaining access to said instant messenger after successful authentication, and providing access to a buddy list;
sending and receiving messages using a text box to contacts listed in said buddy list; and
viewing the conversation between said contacts.

2. The method of claim 1, further comprising the step of gaining access to the instant messenger using a password protected authentication.

3. The method of claim 1, further comprising the step of displaying a list of contacts in a buddy list bar within said instant messenger.

4. The method of claim 1, further comprising the step of providing a field to view the conversation between selected contacts using a conversation box.

5. The method of claim 1, wherein the login drop down box provides a list of various instant messenger service providers.

6. The method of claim 1, wherein said buddy list bar displays the name of the selected contacts in the toolbar.

7. The method of claim 1, wherein said buddy list bar indicates arrival of a message.

8. The method of claim 1, further comprising the step of providing mail alerts in the text box of the instant messenger.

9. The method of claim 1, wherein the toolbar indicates the status of each contact.

10. The method of claim 1, wherein the toolbar comprises a weather tab to provide latest weather updates.

11. The method of claim 1, wherein the toolbar displays stock market tab to provide latest stock market updates.

12. The method of claim 1, wherein the toolbar displays news tab to provide latest news updates.

13. The method of claim 1, wherein the toolbar provides a means of interactive co-browsing.

14. The method of claim 1, wherein the text box in the toolbar is fed with really simple syndication feeds.

15. The method of claim 1, wherein the toolbar provides a method for collaborative composing.

16. The method of claim 8, wherein the toolbar conducts voice over internet protocol.

17. A method of communication, comprising the steps of:
providing a web browser with a toolbar;
integrating an instant messenger on said tool bar over said web browser; and
providing really simple syndication feeds to a text box within said instant messenger.
